(19) United States
(12) Patent Application Publication
(10) Pub. No.: US 2014/0084834 A1
(43) Pub. Date: Mar. 27, 2014

(54) Electronic Control Device

(71) Applicant: HITACHI AUTOMOTIVE SYSTEMS, LTD., Hitachinaka-shi (JP)

(72) Inventor: Hiroyuki SAITO, Hitachinaka-shi (JP)

(73) Assignee: Hitachi Automotive Systems, Ltd., Hitachinaka-shi (JP)

(21) Appl. No.: 13/860,098

(22) Filed: Apr. 10, 2013

(30) Foreign Application Priority Data
Sep. 21, 2012 (JP) 2012-208926

(51) Int. Cl. H02P 29/00

(52) U.S. Cl. CPC H02P 29/0044
USPC 318/473

(57) ABSTRACT

Disclosed is an electronic control device for controlling an electric actuator, which includes: a housing fixed to an outer side of an exterior part of the electric actuator; a circuit board accommodated in an inner space of the housing; a temperature sensor mounted on the circuit board; and a heat transfer part having a thermally conductive relay member extending from the circuit board in a direction toward the exterior part to define a continuous heat transfer path from the temperature sensor to an inner side of the exterior part such that heat of the inner side of the exterior part can be transferred to the temperature sensor through the heat transfer path.

### BACKGROUND OF THE INVENTION

The present invention relates to an electronic control device for controlling an electric actuator.

Various technologies using electric actuators, such as regenerative coordination brakes, have recently become widespread. For example, there is known a combined system that includes an electric actuator for braking control (e.g. brake fluid pressure control) of the vehicle by means of an electric motor (e.g. an electric motor driven by three-phase alternating current power) and an electronic control device for drive control of the electric motor according to driver's braking operation and vehicle running conditions.

In general, there is a possibility of system failure when the electric actuator reaches a high temperature due to heat generation caused by driving of the electric motor etc. In order to prevent such system failure, it is conceivable to restrict a temperature increase in the electric actuator by arranging a temperature sensor on or adjacent to an exterior part of the electric actuator and allowing the electronic control device to analyze temperature changes in the electric motor detected by the temperature sensor and perform drive control (energization control) of the electric motor based on the analysis results as disclosed in Japanese Laid-Open Patent Publication No. 2005-132141.

### SUMMARY OF THE INVENTION

In the above-mentioned actuator control technique, however, the type of the temperature sensor applicable to the electric actuator is limited for some reasons such as complex structure of the electric actuator. Further, the accuracy of analysis of the temperature changes in the electric actuator may be lowered due to variation in the positioning of the temperature sensor. In addition, the above-mentioned actuator control technique requires a plurality of connectors or a harness and complicated operation for connection of the temperature sensor to the electronic control device. This leads to an increase in product cost due to the increasing numbers of sensor connection parts and operation tasks.

In view of the above problems, it is an object of the present invention to provide an electronic control device capable of detecting and analyzing temperature changes in an electric actuator by means of a temperature sensor while limiting the numbers of parts and operation tasks for connection of the temperature sensor to the electronic control device.

According to one aspect of the present invention, there is provided an electronic control device for controlling an electric actuator, comprising: a housing fixed to an outer side of an exterior part of the electric actuator; a circuit board accommodated in an inner space of the housing; a temperature sensor mounted onto the circuit board; and a heat transfer part having a thermally conductive relay member extending from the circuit board in a direction toward the exterior part to define a continuous heat transfer path from the temperature sensor to an inner side of the exterior part such that heat of the inner side of the exterior part can be transferred to the temperature sensor through the heat transfer path.

It is possible according to one aspect of the present invention that the electronic control device can detect and analyze temperature changes in the electric actuator by means of the temperature sensor while limiting the numbers of parts and operation tasks for connection of the temperature sensor to the electronic control device so as to contribute to a reduction in cost.

The other objects and features of the present invention will also become understood from the following description.

### BRIEF DESCRIPTION OF THE DRAWINGS

FIGS. 1 and 2 are exploded perspective views of an actuator system equipped with an electronic control device according to each of first to fourth embodiments of the present invention (viewed from different angles).

FIG. 3 is an exploded perspective view of the electronic control device according to each of the first to fourth embodiments of the present invention.

FIG. 4 is a cross-section view of the electronic control device, taken along line B-B of FIG. 2, according to each of the first to fourth embodiments of the present invention.

FIG. 5 is a perspective view of a housing case of the electronic control device according to each of the first to fourth embodiments of the present invention.

FIGS. 6 and 7 are a cross-section view and a plan view of a heat transfer part of the electronic control device according to the first embodiment of the present invention, respectively.

FIG. 8 is a cross-section view of a heat transfer part of the electronic control device according to the second embodiment of the present invention.

FIG. 9 is a cross-section view of a heat transfer part of the electronic control device according to the third embodiment of the present invention.

FIG. 10 is a cross-section view of a heat transfer part of the electronic control device according to the fourth embodiment of the present invention.

FIG. 11 is a diagram showing the characteristics of temperature changes detected by a temperature sensor depending on the position of the temperature sensor (areas A and B).

FIG. 12 is a diagram showing the self-heat generating temperature characteristics of heat generating electronic components (components A to C).

### DESCRIPTIONS OF THE EMBODIMENTS

In contrast to the conventional technique in which the temperature sensor is arranged on or adjacent to the electric actuator (e.g. inside the actuator exterior part such as motor housing) for direct detection of temperature changes in the electric actuator, the electronic control device according to one aspect of the present invention is characterized in that: the temperature sensor is mounted onto the circuit board; and the heat transfer path is defined between the electric actuator and the temperature sensor by the heat transfer part (means). More specifically, the heat transfer part (means) has a structure that the thermally conductive relay member extends from the circuit board in the direction toward the actuator exterior part to define the heat transfer pass for transferring the heat of the inner side of the actuator exterior part to the temperature sensor.

The concept of the present invention is completely different from that of the conventional technique in that, whereas the temperature changes in the electric actuator are detected directly by the temperature sensor in the conventional technique, the temperature changes in the electric actuator are detected by the temperature sensor indirectly through the heat transfer part for temperature analysis and control of the electric actuator in the present invention. Thus, the present invention is free from the above-mentioned problems of the conventional technique and has the advantages that: the temperature sensor can be of various types as long as the temperature sensor is mountable by e.g. surface mounting onto the circuit board; there is no need to perform sensor connection operation using a plurality of connectors or a harness; and variation in the positioning of the temperature sensor can be restricted. Even though the temperature sensor is located apart from the electric actuator, the heat of the electric motor is transferred to the temperature sensor through the heat transfer part (heat transfer path) so that the temperature changes in the electric actuator can be adequately detected by the temperature sensor. The characteristics of the temperature changes detected indirectly by the temperature sensor through the heat transfer part vary depending on the thermal conductivity of the heat transfer part, the position of the temperature sensor (the length of the heat transfer part) and the like. Although there is some difference (e.g. difference in temperature change value or time lag) between the characteristics of the temperature changes detected indirectly by the temperature sensor and the characteristics of the temperature changes detected directly by the temperature sensor, both of these temperature change characteristics are in correlation with each other.

The electronic control device is therefore able to analyze the driving state of the electric actuator adequately even based on the temperature changes in the electric actuator detected indirectly by the temperature sensor. Further, the electronic control device is reduced in cost by the use of the limited numbers of parts and operation tasks for connection of the temperature sensor as compared to the conventional the technique.

There is no particular limitation of the material and shape of the heat transfer part in the present invention. The heat transfer part can be of various materials and shapes as long as the heat transfer part is capable of, when heat is generated by driving of an electric motor etc. in the electric actuator, transferring the heat from the inner side of the actuator exterior part to the temperature sensor.

The heat transfer part consists of a single member or a plurality of members. For example, the heat transfer part may have a plurality of thermally conductive relay members and may have not only the thermally conductive relay member but also a thermally conductive elastic member disposed between the relay member and the circuit board, a pattern member formed by patterning of a thermally conductive material on the circuit board etc. as in the after-mentioned embodiments. These thermally conductive members can be used in any appropriate combination.

In the case where the heat transfer member has a plurality of thermally conductive members, the thermally conductive members may be located apart from each other without being connected to each other or may be located to constitute the heat transfer path between the inner side of the actuator exterior part and the temperature sensor. The locations of the thermally conductive members are not particularly limited as long as the heat transfer path is defined between the actuator exterior part and the temperature sensor through the thermally conductive members.

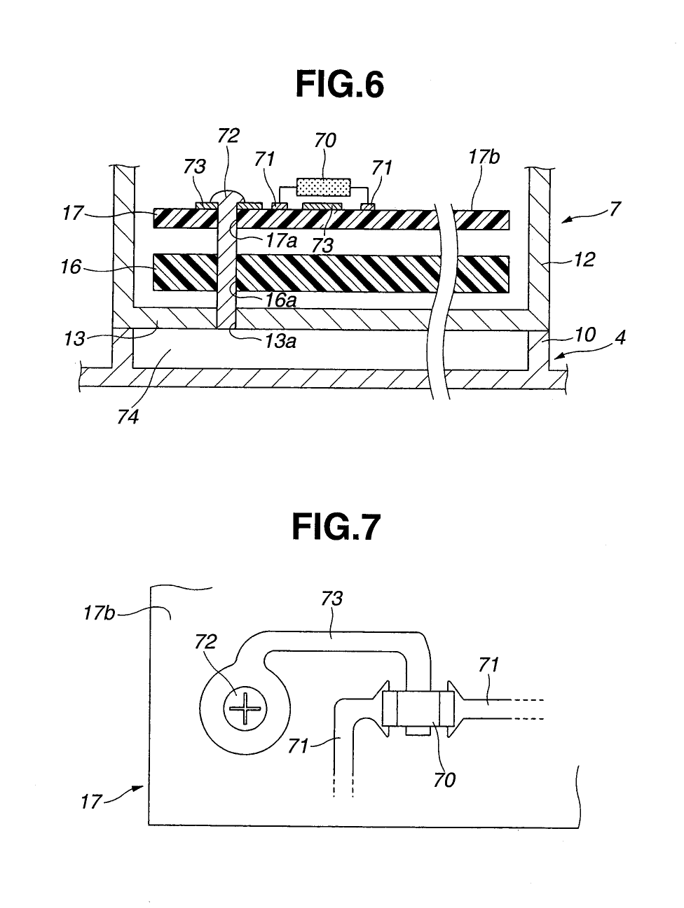

In the case where the housing and the actuator exterior part are of thermally conductive materials, both of the housing and the actuator exterior part performs the same function as the thermally conductive members of the heat transfer part and thereby constitute a part of the heat transfer path. In the after-mentioned embodiment of FIG. 6, for example, the heat transfer path is defined through the actuator exterior part (motor housing 4), the housing (housing case 12) and then the thermally conductive relay member (relay member 72).

The thermal conductivity of the heat transfer path can be increased by forming the thermally conductive pattern member can be formed on the circuit board as the structural constituent of the heat transfer part in the case where the circuit board or any other part of low thermal conductivity material such as resin is located between the thermally conductive members (e.g. when the thermally conductive relay member is located apart from the temperature sensor).

In the case where the housing has a thermally conductive structural member(s), such a housing member(s) may be used as the thermally conductive member(s) of the heat transfer part. It is, for example, feasible to use any fixing means such as screw for fixing the circuit board to the housing as the thermally conductive relay member in the case where the fixing means is of a thermally conductive material and extends from the circuit board in the direction toward the actuator exterior part.

When the temperature sensor outputs a detection signal response to the detected temperature change in the electric actuator, the detection signal of the temperature sensor is transmitted to a CPU (central processing unit) or memory through e.g. a signal pattern layer of the circuit board. Then, the CPU analyzes the driving state of the electric actuator by processing of the sensor detection signal and outputs a drive command signal (control signal) for drive control of the electric actuator based on the analysis results.

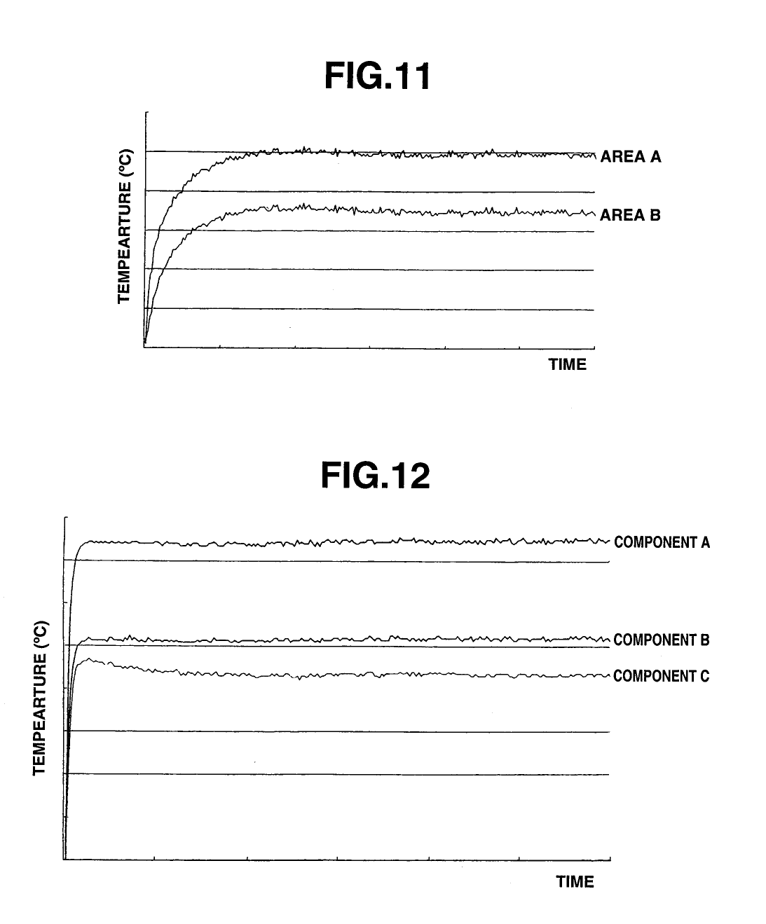

As mentioned above, there is some difference between the temperature change values detected directly by the temperature sensor and detected indirectly by the temperature sensor through the heat transfer part. It is feasible to reduce such a difference by the following method. Data about the characteristics of temperature changes detected directly by the temperature sensor and detected indirectly by the temperature sensor is collected in advance. A calculation factor for cancelling out (or minimizing) the difference between these temperature change characteristics is determined based on the collected data, and then, applied (e.g. added) to the detected temperature change value. As the difference between the directly and indirectly detected temperature change values is larger in the case where the temperature sensor is located at a position relatively close to the motor housing (area A) than in the case where the temperature sensor is located at a position relatively far apart from the motor housing (area B) as shown in FIG. 11, it is desirable to determine the calculation factor based on the difference between the directly and indirectly detected temperature change values according to the position of the temperature sensor. In this way, the approximate calculation of the actual temperature changes in the electric actuator can be done by processing the detected temperature change value with the above-obtained calculation factor.

There is no particular limitation on the type of the temperature sensor as long as the temperature sensor is capable of being mounted onto the circuit board by e.g. surface mounting and detecting the heat transferred thereto through the heat transfer part. Various types of temperature sensor can be used in the present invention. One example of the temperature sensor is a thermistor element that changes in electrical resistance in response to temperature changes.

There is also no particular limitation on the mounted position of the temperature sensor as long as the temperature sensor is mounted onto the circuit board. The temperature sensor is preferably mounted on a portion of the circuit board that that is not affected by any heat source other than the heat transfer part and, more specifically, mounted at a given distance apart from the heat generating electronic components (such as CPU and switching elements) and wiring lines in contact with the heat generating electronic components on the circuit board.

In the case where a signal pattern layer is formed on the circuit board for signal transmission from the temperature sensor to the CPU, the signal pattern layer is preferably not affected by the heat transfer part as well as by any heat source other than the heat transfer part. It is thus preferable, e.g. when the thermally conductive pattern member is provided on the circuit board, to avoid intersection between the signal pattern layer and the pattern member. It is also preferable, when the circuit board is a multilayer circuit board having respective layers equipped with heat generating electronic components (and wiring lines), not to align the temperature sensor and the signal pattern layer in the vertical directions of the heat generating electronic components (i.e. in the lamination direction of the multilayer wiring board).

As shown in FIG. 12, the self-heat generating temperature characteristics of the heat generating electronic components can be defined uniquely depending on the kinds of the heat generating electronic components (components A, B and C). In the case where there is a possibility that the temperature sensor will be affected by self-heat generation of the heat generating electronic components, it is feasible to determine a calculation factor in advance by quantification of the influence of self-heat generation of the heat generating electronic components and apply the calculation factor to the above-mentioned processing operation so that the influence of self-heat generation of the heat generating electronic components can be eliminated from the analysis results.

The present invention will be described in more detail below by way of the following first to fourth embodiments with reference to the drawings. It is herein noted that, in the drawings, like parts and portions are designated by like reference numerals to avoid repeated explanations thereof.

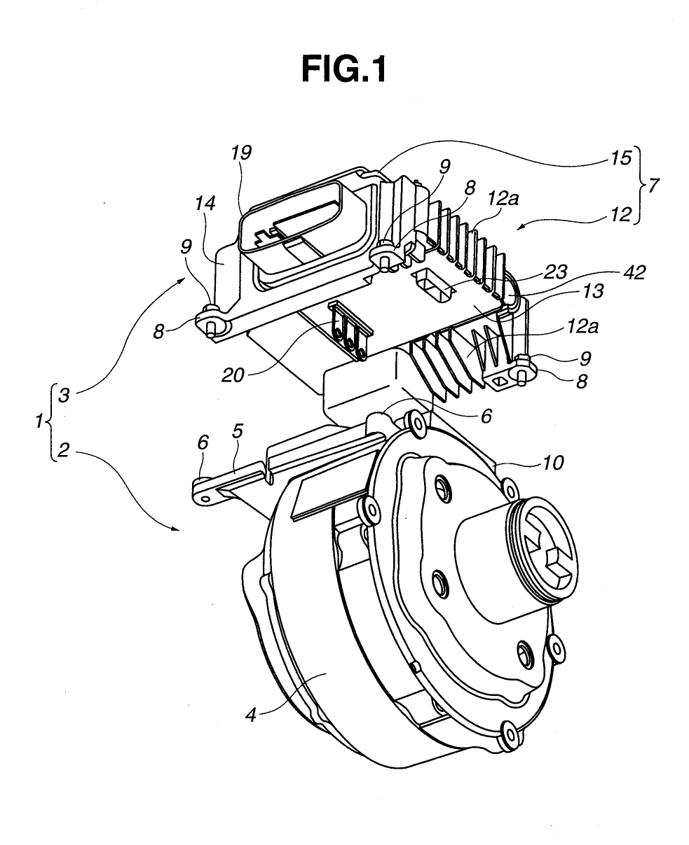

As shown in FIGS. 1 to 5, each of the first to fourth embodiments refers to an actuator system 1 for a brake apparatus (electric brake booster) in an automotive vehicle.

In each embodiment, the actuator system 1 includes an electric actuator having an electric motor 2 accommodated in a motor housing 4 (as an actuator exterior part) and driven by three-phase alternating current power for brake fluid pressure control of the brake apparatus and a motor controller 3 (as an electronic control device) having a plurality of circuit boards such as a power module 16 and a control module 17 accommodated in a controller housing 7 for drive control of the electric motor 2 according to driver's braking operation and vehicle running conditions. Although not shown in the drawings, the electric motor 2 is equipped with a so-called ball-screw mechanism to actuate a brake-fluid pressure control piston of the brake apparatus.

The basic structure of the actuator system 1 will be first explained below.

The motor housing 4 has, on an outer circumferential surface thereof, a pair of motor mount parts 5 extending in an axis direction of the electric motor 2 with a given distance left therebetween in a direction perpendicular to the axis direction of the electric motor 2. Circular seat portions 6 with screw holes 6a are formed protrudingly on longitudinally opposite ends of the respective motor mount parts 5.

On the other hand, the controller housing 7 (the after-mentioned housing case 12) has four leg portions 8 formed on a bottom thereof.

The motor controller 3 (the controller housing 7) is thus fixed to the electric motor 2 (the motor housing 4) by seating the leg portions 8 of the controller housing 7 on the seat portions 6 of the motor housing 4 and inserting fixing screws 9 into the leg portions 8 and the screw holes 6a, respectively.

The motor housing 4 also has a substantially rectangular circumferential wall portion 10 formed protrudingly between the motor mount parts 5 such that, in a state that the controller housing 7 is fixed to the motor housing 4, connection parts 20 and 23 of the motor controller 3 face the inside of the motor housing 4 through an opening 11 of the circumferential wall portion 10. Herein, the connection part 20 is equipped with a terminal for connection with a stator of the electric motor 2 inside the motor housing 4; and the connection part 23 is connected with a harness of a rotation sensor inside the motor housing 4. The rotation sensor is adapted, as is well known, to detect a rotational position of a rotor of the electric motor 2 inside the motor housing 4 and output a signal to the motor controller 3 for drive control of the electric motor 2.

A groove 10a is made in a top end of the circumferential wall portion 10 of the motor housing 4 around the opening 11 continuously in an endless manner. A seal member is fitted in the groove 10a and pressed onto the controller housing 7 (the after-mentioned housing case bottom wall 13) so as to provide a seal between the inside and outside of the motor housing 4.

As shown in FIGS. 1 to 3, the controller housing 7 consists of a housing case 12 and a cover 15. The housing case 12 is substantially rectangular in shape when viewed in plan and has a bottom wall 13 and a circumferential wall 14 surrounding four sides thereof to define a top opening and rim. The cover 15 is substantially rectangular in shape when viewed in plan and is shaped to close the top opening of the housing case 7. In this controller housing 7, the power module 16 and the control module 17 are stacked and accommodated. More specifically, the power module 16 is situated adjacent to the bottom wall 13 of the housing case 12; and the control module 17 is situated above the power module 16 (on a side of the power module 16 opposite from the bottom wall 13 of the housing case 12). The controller housing 7 is attached to the motor housing 4 with the bottom wall 13 of the housing case 12 directed to the motor housing 4.

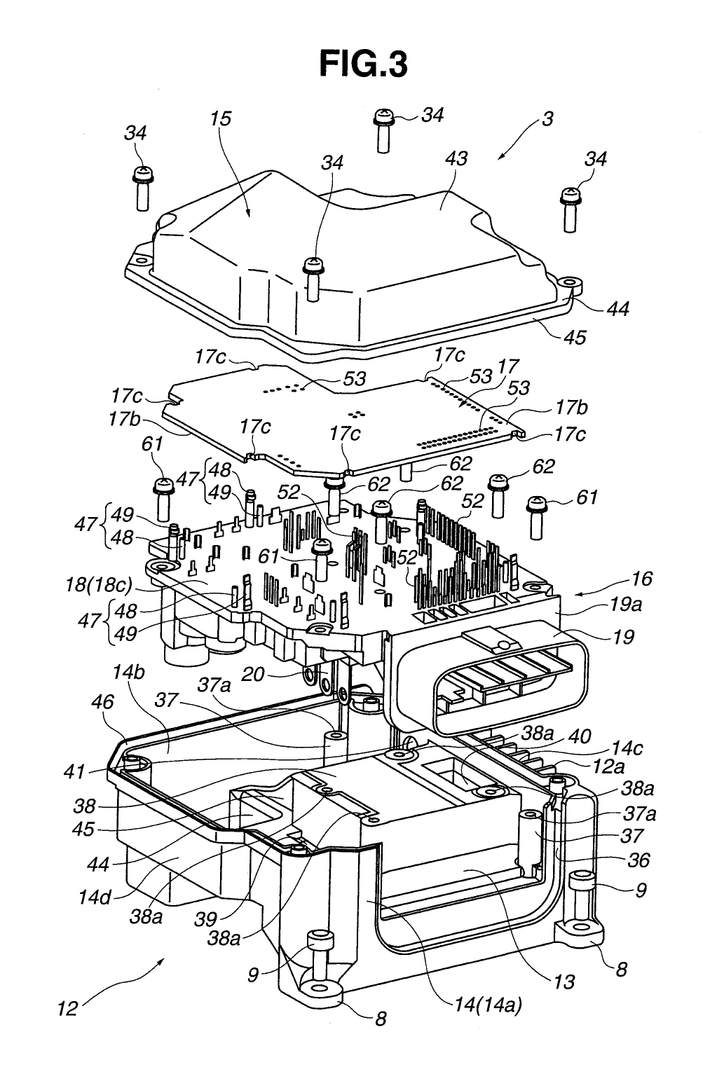

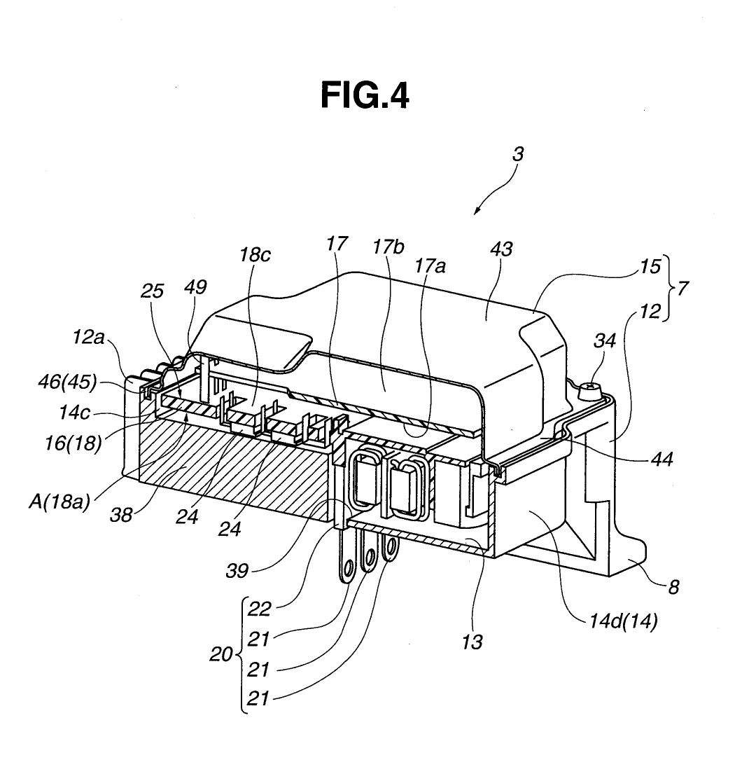

The cover 15 is produced by e.g. press-forming a metal plate into a substantially rectangular pan shape. As shown in FIGS. 3 and 4, the cover 15 includes an expanded portion 43 expanded on the side thereof opposite from the housing case 12 so as to accommodate therein the control module 17, a flanged portion 44 formed around an outer circumferential edge of the expanded portion 43 and a protruding edge portion 45 formed by bending an outer circumferential edge of the flanged portion 44 toward the bottom (toward the housing case 12).

The housing case 12 is produced by e.g. die-casing an aluminum alloy of relatively high thermal conductivity. As shown in FIGS. 3 to 6, the housing case 12 (circumferential wall 14) includes first to four circumferential wall portions 14a to 14d to surround therein the power module 16. An opening 36 is made in the first circumferential wall portion 14a of the housing case 12 14 by cutting away a major part of the first circumferential wall portion 14a from the top side such that an external connector 19 of the power module 16 is inserted in the opening 36. A flanged base portion 19a of the external connector 19 is fitted in the opening 36 and fixed to an edge of the opening 36 by an adhesive seal material. Further, a cooling fin 12a is formed on an outer surface of the third circumferential wall portion 14c of the housing case 12 as shown in FIGS. 3 to 5.

A continuous seal groove 46 is made in a top edge of the circumferential wall 14 of the housing case 12 and in an upper edge of the flanged base portion 19a of the external connector 19. The cover 15 is secured to the housing case 12 by a plurality of cover securing screws with the protruding edge portion 45 of the cover 15 inserted in the seal groove 46. Although not specifically shown in the drawings, a seal material is filled in the seal groove 46 so as to provide a seal between the housing case 12 and the cover 15.

The housing case 12 further includes four substantially cylindrical-column power-module support portions 37 and a block-shaped protruding portion 38. The power-module support portions 37 are formed at around four corners of the bottom wall 13 so as to protrude from the bottom wall 13 toward the cover 15. Screw holes 37a are made in top ends of the power-module support portions 37, respectively, for insertion of power-module mounting screws 61. The protruding portion 38 is formed in a rectangular block shape on the bottom wall 13 so as to correspond in position to a switching element mounting region of the power module 16 and serve as a heat sink of high thermal capacity.

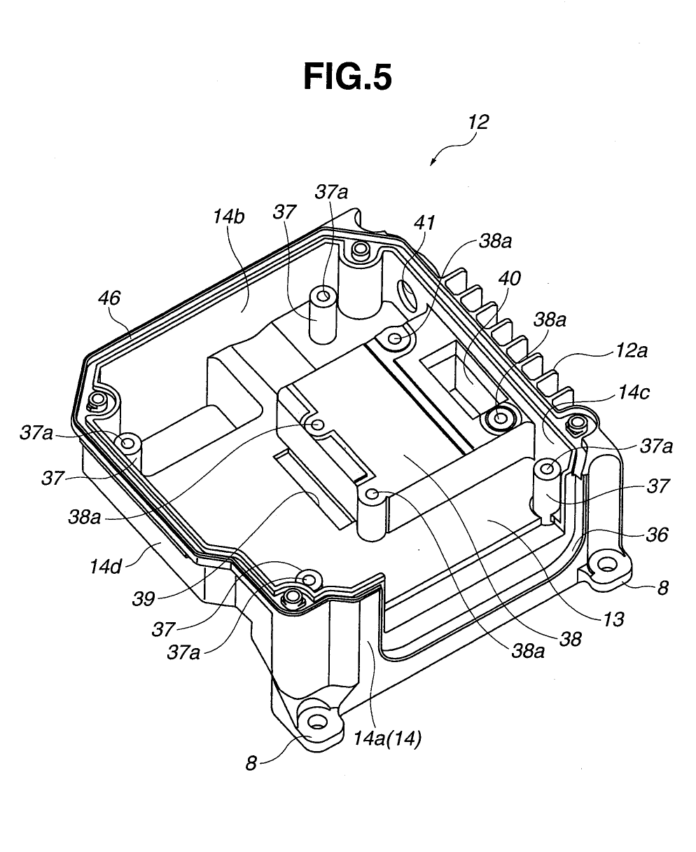

As shown in FIG. 5, the block-shaped protruding portion 38 is located substantially in the center of the housing case 12 and is formed integral with the third circumferential wall portion 14c, with a given distance left between the protruding portion 38 and each of the opposite first and second circumferential wall portions 14a and 14b and a given distance left between the protruding portion 38 and the fourth circumferential wall portion 14d (opposite from the third circumferential wall portion 14c). Four screw holes 38a are made in four corner regions of a top surface of the block-shaped protruding portion 38 for insertion of power-module mounting screws 62.

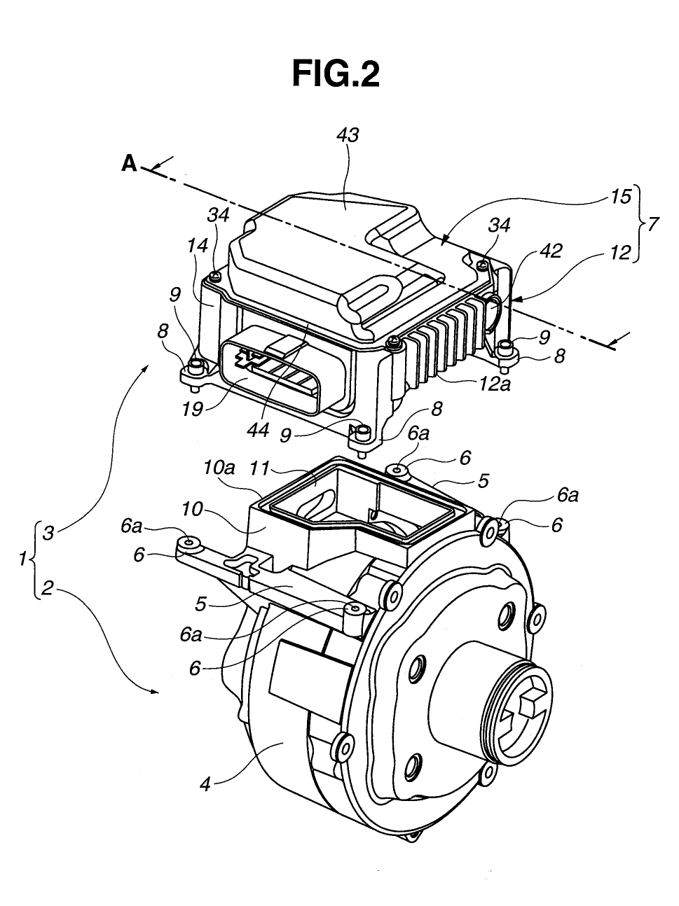

Further, a substantially rectangular connector insertion hole 40 is made through an end part of the block-shaped protruding portion 38 adjacent to the third circumferential wall portion 14c. A power supply terminal insertion hole 39 is made through a corner between an end face of the block-shaped protruding portion 38 facing the fourth circumferential wall portion 14d and the bottom wall 13 of the housing case 12. An aeration hole 41 is made through a part of the third circumferential wall portion 14c closer to the second circumferential wall portion 14b than the block-shaped protruding portion 38 such that an aeration filter 42, which has air permeability but does not have water permeability, is attached to the aeration hole 41 (see FIGS. 1 and 2).

The power module 16 has a substantially plate-shaped module substrate 18, as shown in FIGS. 3 and 4, formed by e.g. die molding of a synthetic resin material with a plurality of metal busbars inserted therein or in a surface thereof. The external connector 19 is formed integral with one end face of the module substrate 18 as a power supply connector for power and signal transmission with external equipment through the opening 36 of the housing case 12. The power module 16 also has a plurality of electronic components such as switching elements 24 mounted on a component mounting surface 18a of the module substrate 18 facing the bottom wall 13 of the housing case 12. The stator connection part 20 is formed protrudingly at around the center of the component mounting surface 18. The sensor connection part 23 is formed protrudingly on one end region of the component mounting surface 18. Both of these connection parts 20 and 23 are rectangular plate-shaped and extend in parallel to each other in a direction perpendicular to a plane direction of the module substrate 18.

As shown in FIG. 4, the stator connection part 20 includes three power supply terminals 21 aligned in an axis direction of the external connector 19 (i.e. the external connection direction) and a covering portion 22 formed integral with and from the same material as the module substrate 18 so as to cover respective base ends of the power supply terminals 21. This stator connection part 20 serves as a driving terminal for supply of three-phase driving current to the electric motor 2.

A plurality of snap fitting parts 47 are formed on a control-module-facing surface 18b of the module substrate 18 opposite from the component mounting surface 18a so as to protrude in a direction perpendicular to the plane direction of the module substrate 18 and hold the control module 17 by so-called snap fitting as shown in FIG. 3. Each of the snap fitting parts 47 includes a control-module support portion 48 and a holding piece 49. A plurality of connection terminals 52 are also formed on the control-module-facing surface 18b of the module substrate 18 for electrical connection between the power module 16 and the control module 17.

The control module 17 has a module substrate formed of a non-conductive resin material such as glass/epoxy resin, wiring patterns arranged on both sides of the module substrate and a plurality of electronic components such as CPU mounted on the wiring patterns. Cuts 17c are made in an outer circumferential edge of the control module 17 at positions corresponding to the holding pieces 49 so as to fit with the cross-sectional profiles of bodies of the holding pieces 49, respectively.

For assembling of the power module 16 and the control module 17, the control module 17 is seated on the control-module support portions 48 of the power module 16. Further, the snap fit parts 47 of the power module 16 are attached to the control module 17 by engaging the bodies of the holding pieces 49 in the cuts 17c of the control module 17 and engaging hook-shaped tip ends of the holding pieces 49 on a cover-facing surface 17b of the control module 17. The control module 17 is thus fixed in position by the snap fit parts 47 in parallel with the power module 16 (module substrate 18), with a given distance left between the power module 16 and the control module 17 in the direction perpendicular to the plane direction of the module substrate 18, while being located inside the cover 15 from the opening end of the housing case 12 and accommodated in the expanded portion 43 of the cover 15.

As shown in FIG. 3, through holes 53 are made in the control module 17 at positions corresponding to the connection terminals 52 of the power module 16 so that the connection terminals 52 are inserted in and electrically connected by soldering to the respective through holes 53.

When the control module 17 inputs information about the driver's braking operation and vehicle running conditions into the CPU through the external connector 10 and the connection terminals 52, the CPU performs processing operation on the input information, generates a drive command signal according to the processing results, and then, outputs the drive command signal to the switching elements 24 through the connection terminals 52. The electric motor 2 is driven by switching operation of the switching elements 24 under the drive command signal.

### First Embodiment

Next, the characteristic configuration of the first embodiment will be described in detail below with reference to FIGS. 6 and 7.

As shown in FIGS. 6 and 7, the control module 17 has a signal pattern layer 71 formed on the cover-facing surface 17b thereof.

Further, the motor controller 3 has a temperature sensor (thermistor) 70, a thermally conductive relay member 72 and a thermally conductive pattern member 73 as shown in FIGS. 6 and 7. (The relay member 72 and the pattern member 73 constitute a heat transfer part in the first embodiment.)

The temperature sensor 70 is mounted on the cover-facing surface 17b of the control module 17 and connected to the signal pattern layer 17 such that a detection signal of the temperature sensor 70 is transmitted to the CPU through the signal pattern layer 71.

The relay member 72 is formed of a thermally conductive metal material and arranged to extend in a direction toward the motor housing 4 from a point on the control module 17 that is apart from the temperature sensor 70. In the first embodiment, the relay member 72 is in the form of a metal screw that passes through a through hole 17a of the control module 17 and a through hole 16a of the power module 16 and is screwed at a tip end portion thereof in a screw hole 13a of the bottom wall 13 of the housing case 12.

The pattern member 73 is formed by patterning a thermally conductive metal material on a region of the cover-facing surface 17b of the control module 17 between the temperature sensor 70 and the relay member 72. The seal between the circumferential wall portion 10 of the motor housing 4 and the bottom wall 13 of the housing case 12 is provided by the seal member although not shown in the drawings.

In such a configuration, there is defined a continuous heat transfer path from the motor housing 4 to the temperature sensor 70 by the heat transfer part (the relay member 72 and the pattern member 73). The heat transfer path is in the following order: the motor housing 4→the housing case 12→the heat transfer part (the relay member 72→the pattern member 73). Heat of the motor housing 4 is transferred to the temperature sensor 70 through such a heat transfer path whereby temperature changes in the motor housing 4 (that is, temperature changes in the electric motor 2) can be adequately detected by the temperature sensor 70.

As the seal between the circumferential wall portion 10 of the motor housing 4 and the bottom wall 13 of the housing case 12 is provided by the seal member, the heat transferred to the heat transfer part can be prevented from being dissipated to the outside of the controller housing 7. This leads to improvement in the accuracy of detection of the temperature changes by the temperature sensor 70.

In addition, the pattern member 73 is arranged below the center of the temperature sensor 70; and the signal pattern layer 71 is connected to both ends of the temperature sensor 70 as shown in FIGS. 6 and 7 in the first embodiment. This allows a reduction in stress load on terminals of the temperature sensor 70 etc.

### Second Embodiment

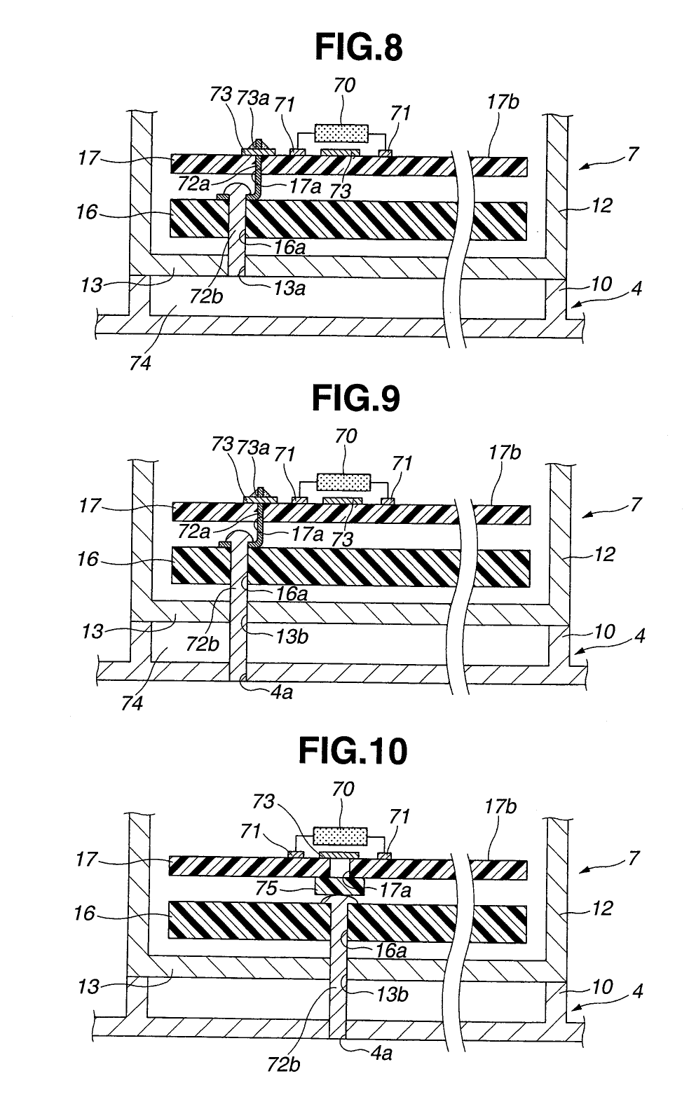

The characteristic configuration of the second embodiment will be described in detail below with reference to FIG. 8. The second embodiment is structurally similar to the first embodiment, except that the heat transfer part includes first and second relay members 72a and 72b as shown in FIG. 8.

The first relay member 72a is formed of a thermally conductive metal material and arranged to extend to the power module 16 from a point on the control module 17 that is apart from the temperature sensor 70. On end portion of the first relay member 72 passes through a through hole 17a of the control module 17 and through the pattern member 73 and is electrically connected by soldering 73a to the pattern member 73. The other end portion of the first relay member 72a is bent to extend along the power module 16.

The second relay member 72b is also formed of a thermally conductive metal material and is arranged to extend toward the motor housing 4 from the point on the power module 16 to which the first relay member 72 is attached. As in the case of the relay member 72 of the first embodiment, the second relay member 72b is in the form of a metal screw and is connected by insertion to the other end portion of the first relay member 72a, inserted through a through hole 16a of the power module 16 and screwed at a tip end portion thereof in a screw hole 13a of the bottom wall 13 of the housing case 12.

There is thus defined a continuous heat transfer path from the motor housing 4 to the temperature sensor 70 by the heat transfer part (the relay members 72a and 72b and the pattern member 73) in such a manner that the heat transfer path is in the following order: the motor housing 4→the housing case 12→the heat transfer part (the second relay member 72b→the first relay member 72a→the pattern member 73). As heat of the motor housing 4 is transferred to the temperature sensor 70 through such a heat transfer path, temperature changes in the motor housing 4 (that is, temperature changes in the electric motor) can be adequately detected by the temperature sensor 70.

### Third Embodiment

The characteristic configuration of the third embodiment will be described in detail below with reference to FIG. 9. The third embodiment is a modified example of the second embodiment and is structurally different in that the heat transfer part extends to the motor housing 4.

As shown in FIG. 9, the tip end portion of the second relay member 72b passes through a through hole 13b of the bottom wall 13 of the controller housing 7 and is screwed in a screw hole 4a of the motor housing 4 in the third embodiment.

There is thus defined a continuous heat transfer path from the motor housing 4 to the temperature sensor 70 by the heat transfer part (the relay members 72a and 72b and the pattern member 73) in such a manner that the heat transfer path is in the following order: the motor housing 4→the heat transfer part (the second relay member 72b→the first relay member 72a→the pattern member 73). As heat of the motor housing 4 is transferred to the temperature sensor 70 through such a heat transfer path, temperature changes in the motor housing 4 (that is, temperature changes in the electric motor) can be adequately detected by the temperature sensor 70. Further, it becomes easier in this configuration to transfer the heat from the motor housing 4 to the temperature sensor 70. As the end portion of the heat transfer part (relay member 72b) is inserted inside the circumferential wall portion 10 (opening 11) of the motor housing 4 as shown in FIG. 10, the influence of outside air on the heat transfer part (relay member 72b) can be avoided.

### Fourth Embodiment

The characteristic configuration of the fourth embodiment will be described in detail below with reference to FIG. 10. The fourth embodiment is a modified example of the third embodiment and is structurally different in that the heat transfer part has a thermally conductive elastic member 75 in place of the relay member 72a as shown in FIG. 10.

In the fourth embodiment, the elastic member 75 is in the form of e.g. a thermally conductive elastic sheet and is arranged between the relay member 72b and the through hole 17a of the control module 17.

There is thus defined a continuous heat transfer path from the motor housing 4 to the temperature sensor 70 by the heat transfer part (the relay member 72b, the pattern member 73 and the elastic member 75) in such a manner that the heat transfer path is in the following order: the motor housing 4→the housing case 12→the heat transfer part (the second relay member 72b→the elastic member 75→the pattern member 73). As heat of the motor housing 4 is transferred to the temperature sensor 70 through such a heat transfer path, temperature changes in the motor housing 4 (that is, temperature changes in the electric motor) can be adequately detected by the temperature sensor 70. Even if stress occurs on the heat transfer part (relay member 72), the control module 17 and the like due to vibrations from the motor housing 4 or if dimensional errors occur due to assembling of the heat transfer part and associated parts, the elastic member 75 can release such stress or absorb such dimensional errors.

The entire contents of Japanese Patent Application No. 2012-208926 (filed on Sep. 21, 2012) are herein incorporated by reference.

Although the present invention has been described with reference to the above exemplary embodiments, the present invention is not limited to these exemplary embodiments. Various modification and variation of the embodiments described above will occur to those skilled in the art in light of the above teachings. The scope of the present invention is defined with reference to the following claims.

What is claimed is:

1. An electronic control device for controlling an electric actuator, comprising:
a housing fixed to an outer side of an exterior part of the electric actuator;
a circuit board accommodated in an inner space of the housing;
a temperature sensor mounted on the circuit board; and
a heat transfer part having a thermally conductive relay member extending from the circuit board in a direction toward the exterior part to define a continuous heat transfer path from the temperature sensor to an inner side of the exterior part such that heat of the inner side of the exterior part can be transferred to the temperature sensor through the heat transfer path.

2. The electronic control device according to claim 1, wherein the heat transfer member has a thermally conductive elastic member arranged between the relay member and the circuit board.

3. The electronic control device according to claim 1, wherein the exterior part has a circumferential wall portion protruding from the outer side thereof; wherein the housing is connected and sealed to an opening of the circumferential wall portion of the exterior part; and wherein one end portion of the heat transfer part passes through the housing and is inserted inside the opening of the circumferential wall portion of the exterior part.

4. The electronic control device according to claim 1, wherein the heat transfer member has a pattern member formed by patterning of a thermally conductive material on a region of the circuit board between the temperature sensor and the relay member.

5. The electronic control device according to claim 1, wherein the circuit board has a signal pattern layer formed thereon such that a detection signal of the temperature sensor can be transmitted to a processing unit through the signal pattern layer.

6. The electronic control device according to claim 5, wherein the signal pattern layer is on a region of the circuit board apart from the heat transfer part.

7. The electronic control device according to claim 1, wherein the temperature sensor is mounted on a region of the circuit board apart from a heat generating electronic component.
